(19) United States
(12) Patent Application Publication
(10) Pub. No.: US 2010/0296908 A1
(43) Pub. Date: Nov. 25, 2010

(54) Industrial Automatic Object Transportation System and Operation Method of the Same

(76) Inventor: Chien-Ho Ko, Changhua County (TW)

Correspondence Address: BRIAN M. MCINNIS, 12th Floor, Ruttonjee House, 11 Duddell Street, Hong Kong, HK

(21) Appl. No.: 12/199,177

(22) Filed: Aug. 27, 2008

(30) Foreign Application Priority Data
Jan. 29, 2008 (TW) 97103302

(51) Int. Cl. G05D 1/02; B65G 65/00; B66F 9/075

(52) U.S. Cl. 414/800; 701/23

(57) ABSTRACT

An operation method of an industrial automatic object transportation system includes: determining current positions and orientations of a vehicle by a positioning system and a digital compass device of the industrial automatic object transportation system when the industrial automatic object transportation system is kept in an operation state; moving the vehicle toward a loading area where a plurality of objects are located based on an electronic map of a stock area; scanning the objects to identify a target object and lifting up the target object when the vehicle reaches the loading area; moving the vehicle with the target object toward an unloading area based on the electronic map of the stock area; and determining an unloading location of the target object based on RFID codes of the target object to unload the target object at the unloading location when the vehicle reaches the unloading area.

### RELATED APPLICATIONS

The application claims priority to Taiwan Application Serial Number 97103302, filed Jan. 29, 2008, which is herein incorporated by reference.

### BACKGROUND

1. Field of the Invention

The present invention relates to a robotic apparatus. More particularly, the present invention relates to an industrial automatic vehicle and an operation method of the vehicle, and the vehicle automatically transports objects such as goods and materials to given destinations or locations.

2. Description of Related Art

Typically, forklift trucks are used to unload objects such as goods, materials, and cargo from a train or a truck, and move and transport the objects to destinations such as storehouses or working places.

Although using the forklift trucks to transport objects mitigates manpower and labor costs when it is compared with using labor to manually move the objects, the forklift truck still needs an operator to manipulate. Hence, problem of manpower and labor costs are not completely addressed. Further, manual operation of the forklift trucks may lift the wrong objects, transport the objects to wrong destinations, or hurt someone when the operator makes some mistakes or distractions in operations.

Although some factories use tracks on which transportation vehicles move to transport the objects to eliminate the problems of manual operations of the forklift trucks, the cost of building the track systems is expensive, and a track only can be use to transport for one kind of objects. For companies with different products, using the track system with the transportation vehicles to move the objects is not favorable.

Therefore, there is a need to provide an improved industrial automatic transportation system to mitigate or obviate the aforementioned problems.

### SUMMARY

An object of the present invention is to provide an industrial automatic object transportation system so as to automatically transport objects (such as goods), which lowers labor cost and presets environment coordinates accommodating indoor or outdoor applications.

An operation method of an industrial automatic object transportation system in accordance with the present invention comprises: determining current positions and orientations of a vehicle by a positioning system and a digital compass device of the industrial automatic object transportation system when the industrial automatic object transportation system is kept in an operation state; moving the vehicle toward a loading area where a plurality of objects are located based on an electronic map of a stock area; scanning the objects to identify a target object and lifting up the target object when the vehicle reaches the loading area; moving the vehicle with the target object toward an unloading area based on the electronic map of the stock area; and determining an unloading location of the target object based on RFID codes of the target object to unload the target object at the unloading location when the vehicle reaches the unloading area.

In an embodiment, the positioning system performs procedures comprises: setting environment, setting a reference positioning coordinate, setting positions of walls of the stock area, setting the loading area and setting the unloading area.

In an embodiment, after the step of moving the vehicle toward a loading area where a plurality of objects are located based on an electronic map of a stock area, if the vehicle encounters a barrier during its movement, the vehicle avoids the barrier and keeps moving, if the vehicle does not encounter a barrier, the industrial automatic object transportation system determines whether the vehicle has reached the unloading area, and if the vehicle has not reached the unloading area, the vehicle keeps moving.

In an embodiment, after the step of moving the vehicle with the target object toward an unloading area based on the electronic map of the stock area, if the vehicle encounters a barrier during its movement, the vehicle avoids the barrier and keeps moving, if the vehicle does not encounter a barrier, the industrial automatic object transportation system determines whether the vehicle has reached the unloading area, and if the vehicle has not reached the unloading area, the vehicle keeps moving.

In an embodiment, the operation method further comprises: updating the vehicle based on data provided by the positioning system to move the next object.

An industrial automatic object transportation system in accordance with the present invention comprises a vehicle, a control circuit, a sensing device, a digital compass device and a motor control circuit. The vehicle comprises a body, a plurality of front wheels, a plurality of rear wheels and a fork. The control circuit is mounted in the body and has a programmable capability to perform controlling procedures of operating the body. The sensing device is mounted on a periphery of the body to sense a barrier to avoid and an object to transport. The digital compass device is mounted on the body to provide an omnidirectional detection angle and access built-in angle data of the control circuit through a transmission interface. The motor control circuit controls turnings of the rear wheels and moving the vehicle based on the omnidirectional detection angle provided by the digital compass device.

In an embodiment, the sensing device comprises a plurality of sensors and a wireless reader. Each of the sensors comprises a transmitter and a receiver. The wireless reader is a RFID reader. The transmission interface is a serial interface, and the serial interface is a wireless RS-232 converter. The motor control circuit comprises a first motor controller driving the front wheels, a second motor controller driving the fork, and a servo motor turning the rear wheels.

In an embodiment, the system further comprises a camera device providing determination of a plurality of objects that whether a target object is found by a visual identification technique.

Consequently, the present invention manipulates all operations of the vehicle with a programmable control circuit, the vehicle automatically transports objects without any labor power. Also, the vehicle automatically avoids the barriers during transportation, finds the target object and moves the object to a given location. Thus, automatic transportation of the objects is accomplished.

### BRIEF DESCRIPTION OF THE DRAWINGS

These and other features, aspects, and advantages of the present invention will become better understood with regard to the following description, appended claims, and accompanying drawings where:

FIG. 1a and FIG. 1b are a flow chart of an operation method of an automatic object transportation system in accordance with the present invention;

FIG. 2 is a schematic, operational view of the transportation system;

FIG. 3 is a block diagram of the transportation system;

FIG. 4 is a perspective view of a vehicle of the transportation system; and

FIG. 5 is a top view of the vehicle in FIG. 4.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

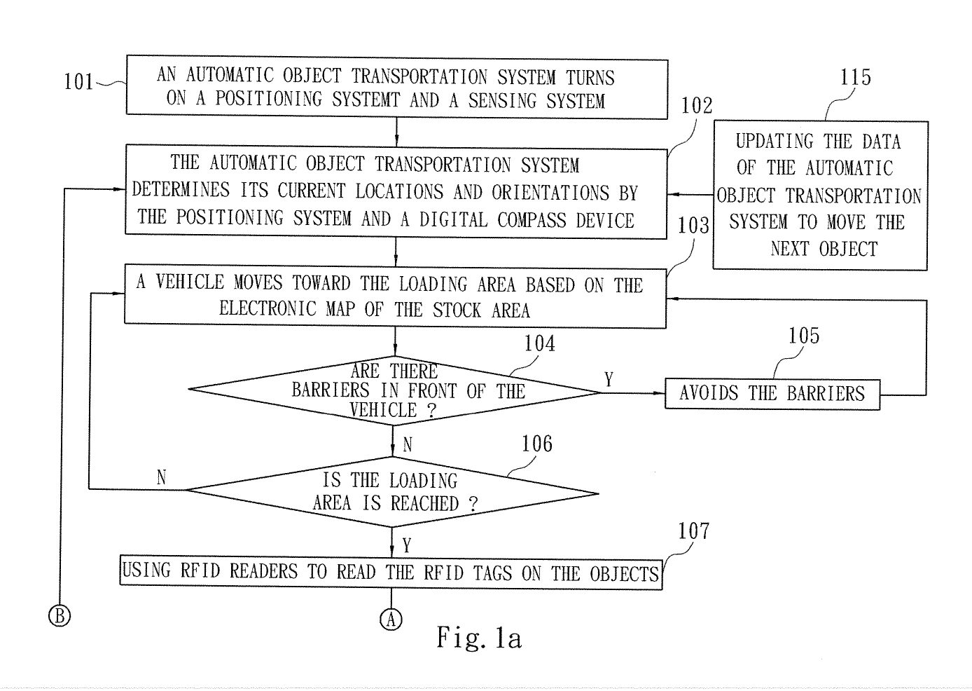

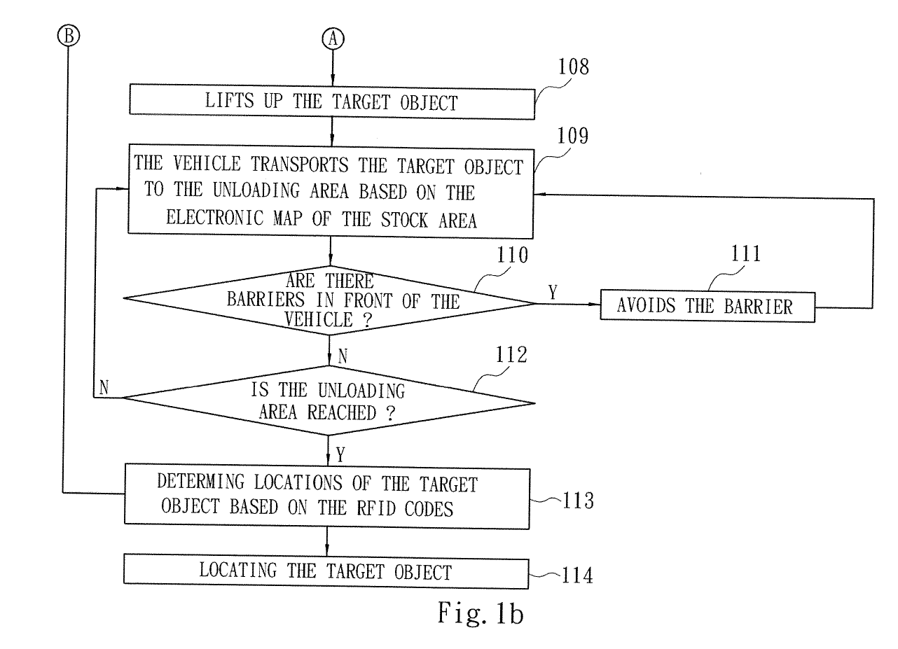

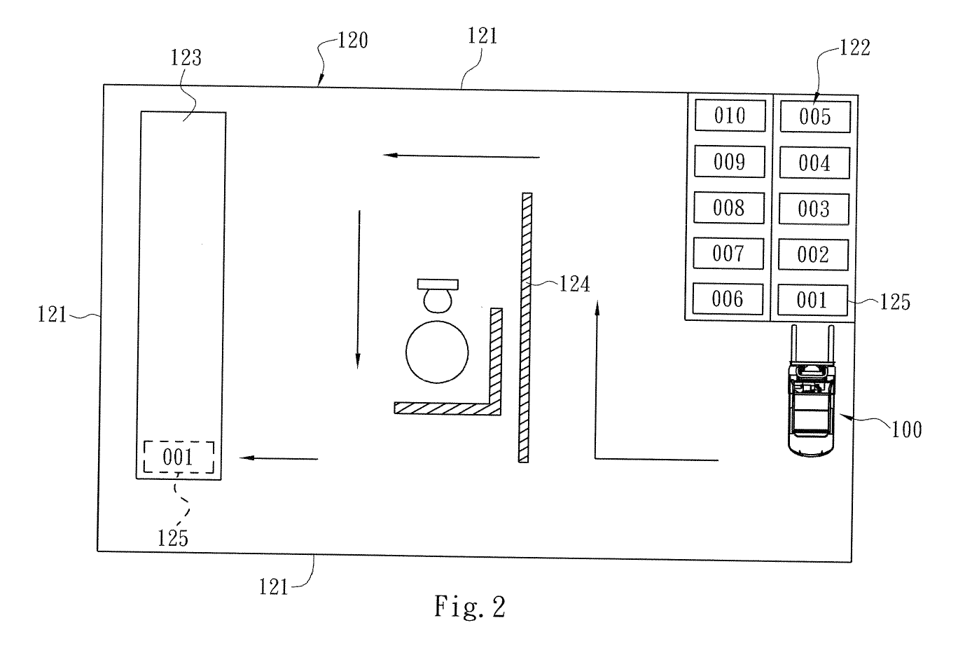

Refer to FIG. 1a, FIG. 1b and FIG. 2. An operation method of an industrial automatic object transportation system comprises steps as follow.

In Step A, a positioning system and a sensing system of an industrial automatic object transportation system are turned on when the automatic object transportation system enters an operation state as shown in step 101 and step 102. The automatic object transportation system determines by itself its current locations and orientations using the positioning system and a digital compass device. The positioning system performs procedures comprising setting environment (i.e. a stock area 120), setting reference positioning coordinates, setting positions of walls 121, setting loading area 122 and setting unloading area 123.

Step B, a vehicle 100 moves toward the loading area 122 (such as an unloading area of a truck) based on the electronic map of the stock area 120 as shown in step 103. If the vehicle 100 encounters barriers 124 during its movement, the vehicle 100 avoids the barriers 124 and keeps moving as shown in step 104 and step 105. If there are no barriers 124 in front of the vehicle 100, the automatic object transportation system determines whether the loading area 122 is reached as shown in step 106. If the vehicle 100 has not reached the loading area 122, the vehicle 100 keeps moving.

Step C, the automatic object transportation system uses radio frequency identification (RFID) readers to read the RFID tags on the objects to identify a target object (such as item 001) 125 as shown in step 107, and the vehicle 100 lifts up the target object when the vehicle 100 has reached the loading area 122 as shown in step 108.

Step D, the vehicle 100 transports the target object to the unloading area 123 based on the electronic map of the stock area 120 as shown in step 109. If the vehicle 100 with the target object encounters the barrier 124 on the way, the vehicle 100 avoids the barrier 124 and keeps moving as shown in step 110 and step 111. If there are no barriers 124 in the way, the automatic transportation system determines whether the vehicle 100 reaches the unloading area 123. If the vehicle 100 has not reached the unloading area 123, the vehicle 100 keeps moving as shown in step 112.

Step E, when the vehicle 100 moves the target object reaching the loading area 122, the vehicle 100 locates the target object (such as item 001) 125 based on the RFID codes as shown in step 113 and step 114. The automatic object transportation system updates its data and controls the vehicle 100 to move the next object (such as item 002). The aforementioned steps are repeated until all objects of a batch (such as items 001 to 010) are transported to and stored in the unloading area 123.

In step A, the automatic object transportation system updates its data such as positioning information of the vehicle 100, coordinate of the objects 125 etc. by the positioning system and the digital compass device as shown in step 115 so that the vehicle 100 can move each of the objects 125.

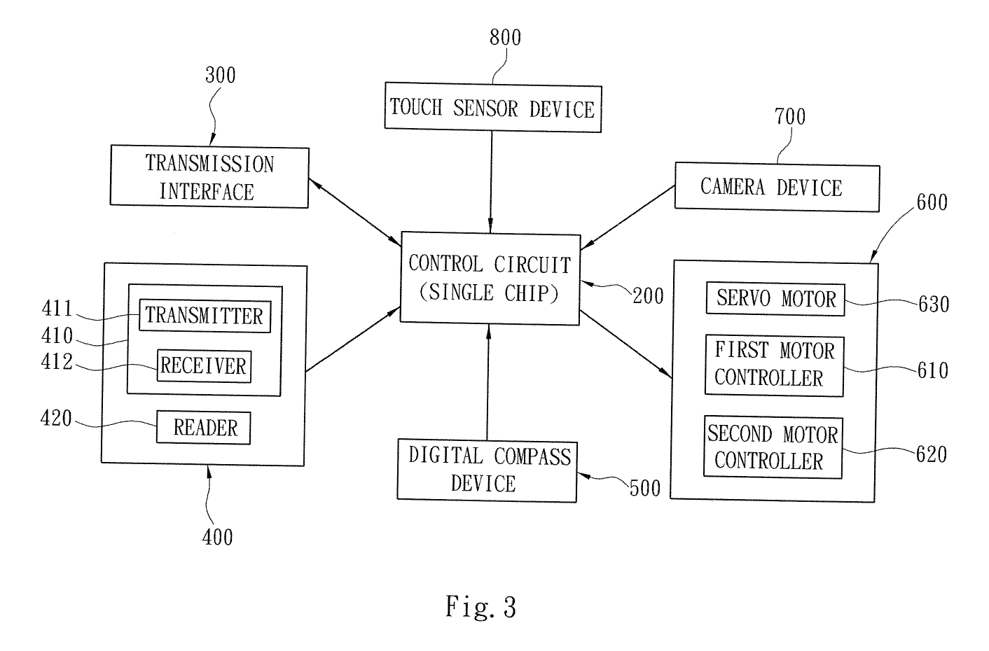

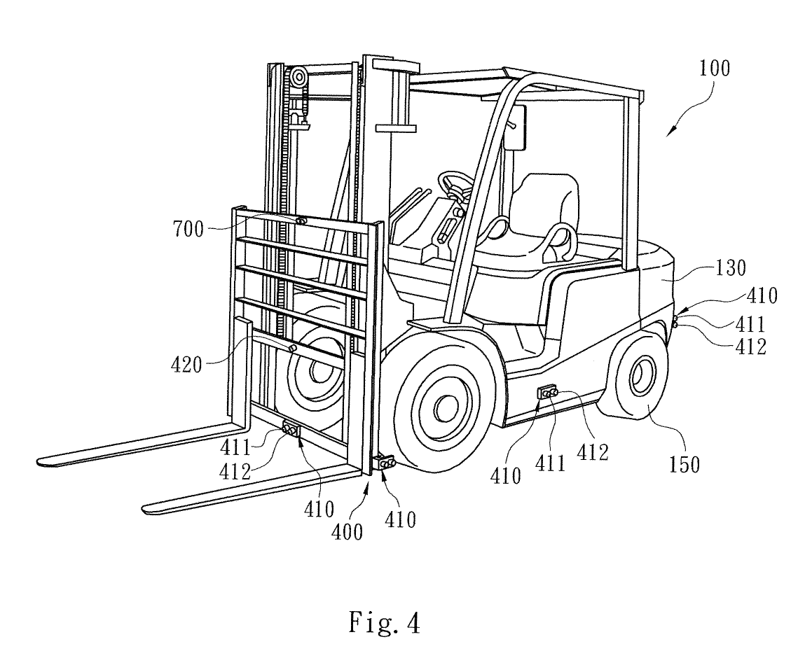

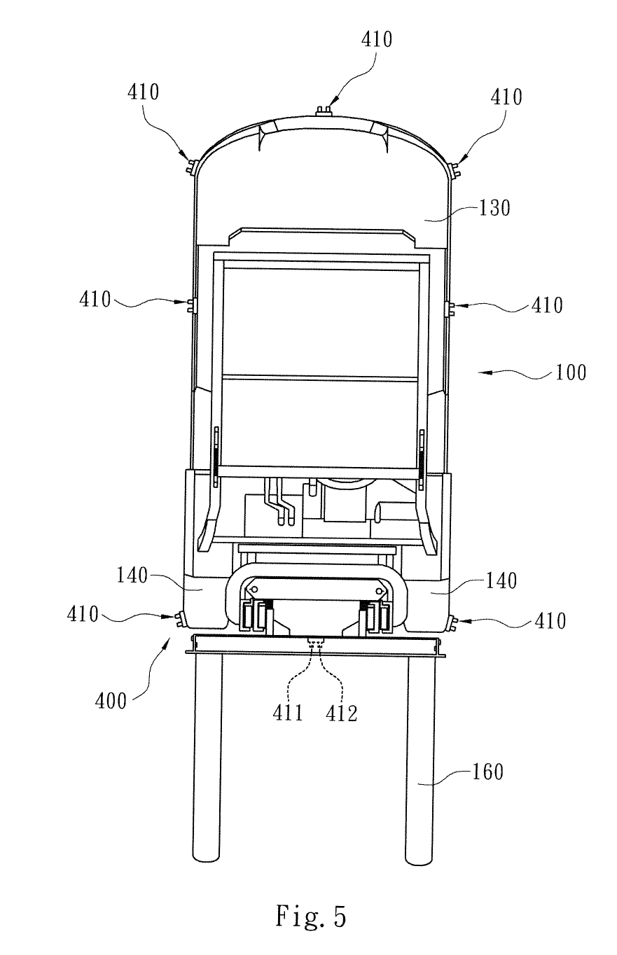

Refer to FIG. 3, FIG. 4 and FIG. 5. The automatic object transportation system in accordance with the present invention comprises the vehicle 100, a control circuit 200, a transmission interface 300, a sensing device 400, a digital compass device 500, a motor control circuit 600, a camera device 700 and a touch sensor device 800.

The vehicle 100 comprises a body 130, a plurality of front wheels 140, a plurality of rear wheels 150 and a fork 160.

The control circuit 200 is mounted in the body 130 and may be a single chip with a programmable capability. Thus, the control circuit 200 can be programmed to perform controlling procedures of operating the body 130.

Further refer to FIG. 5. The sensing device 400 comprises a plurality of sensors 410 and a reader 420. The reader 420 is a wireless reader. Those sensors 410 are respectively mounted at the front-left, the front-right, the rear-left and the rear-right corners of the body 130. Each of the sensors 410 comprises a transmitter 411 and a receiver 412. The transmitter 411 has a sensing distance of 20 meters to sense and detect the barriers 124 and find objects 125. The reader 420 is an RFID reader to read the tags mounted respectively on the objects 125 so that the control circuit 200 can control the transportation of the objects based on the RFID codes.

The digital compass device 500 provides an omnidirectional detection angle and accesses built-in angle data of the control circuit 200 through the transmission interface 300. The transmission interface 300 is a serial interface, and the serial interface is a wireless RS-232 converter.

The motor control circuit 600 comprises a first motor controller 610, a second motor controller 620 and a servo motor 630. The first motor controller 610 controls driving the rear wheels 150 of the vehicle 100 to move, while the second controller 620 controls driving the fork 160 to lift and land. The servo motor 630 drives the rear wheels to turn based on the orientation data provided by the digital compass device 500, which enables the vehicle 100 avoiding the barriers 124 to complete object transportation.

The camera device 700 determines whether the object in front of the vehicle 100 is the barrier 124 of the target object 125. If the determination is that the front object is the target object 125, the vehicle 100 lifts up the target object 125 with the fork 160 to transport.

In addition, please refer to FIG. 3. The touch sensor device 800 is mounted on the fork 160 to sense given positions of the fork 160. When the fork 160 is lifting up and lowering down to the given positions, the touch sensor device 800 is triggered to notice the control circuit to perform the next procedure.

Therefore, the automatic vehicle 100 in accordance with the present invention determines the locations and orientations of the objects 125 (such as goods) by means of the positioning system and the digital compass device 500, and moves toward the loading area 122 to lift the objects 125. The vehicle 100 is an unmanned device that transports objects 125 automatically to the unloading area 123. The vehicle 100 automatically avoids the barriers 124, the wall 121 through the servo motor 630 driving the rear wheel 150 to turn during the object transportation. In addition, the second motor controller 620 controls lifting up or lowering down the fork 160, and the first motor controller 610 controls driving the front wheel 140 to move. The vehicle 100 can totally avoid the barriers 124 and find the correct target object 125 because the sensors 410 provide sensations in all directions for the vehicle 100. Also, the camera device 700 determines if the found object 125 is the target object using visual identification techniques. Next, the sensing device 400 (RFID reader) reads the information of the RFID tag mounted on the target object 125 so that the control circuit 200 controls the vehicle 100 based on the RFID information to automatically move the objects 125 in a predetermined environment (such as the stock area 120) without any mistakes. The labor costs can be lowered. The problems of causing mistakes by transporting manually the objects are eliminated.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An operation method of an industrial automatic object transportation system, and the operation method comprising:
(a) determining a current position and orientation of a vehicle by a positioning system and a digital compass device of the industrial automatic object transportation system when the industrial automatic object transportation system enters in an operation state;
(b) moving the vehicle toward a loading area where a plurality of objects are located based on an electronic map of a stock area;
(c) scanning the objects with RFID to identify a target object and lifting up the target object when the vehicle reaches the loading area;
(d) moving the vehicle with the target object toward an unloading area based on the electronic map of the stock area; and
(e) determining an unloading location of the target object based on an RFID code of the target object to unload the target object at the unloading location when the vehicle reaches the unloading area.

2. The operation method as claimed in claim 1, wherein in the step (a), the positioning system performs procedures comprising setting environment, setting a reference positioning coordinate, setting positions of walls of the stock area, setting the loading area and setting the unloading area.

3. The operation method as claimed in claim 1, wherein after the step (b), if the vehicle encounters a barrier during its movement, the vehicle avoids the barrier and keeps moving, if the vehicle does not encounter a barrier, the industrial automatic object transportation system determines whether the vehicle has reached the unloading area, and if the vehicle has not reached the unloading area, the vehicle keeps moving.

4. The operation method as claimed in claim 1, wherein after the step (d), if the vehicle encounters a barrier during its movement, the vehicle avoids the barrier and keeps moving, if the vehicle does not encounter a barrier, the industrial automatic object transportation system determines whether the vehicle has reached the unloading area, and if the vehicle has not reached the unloading area, the vehicle keeps moving.

5. The operation method as claimed in claim 1, wherein in the step (a) further comprises:
updating the vehicle based on data provided by the positioning system to move a next object.

6. The operation method as claimed in claim 1, wherein after the step (d) further comprises:
repeating step (a) until each of the objects has been transported to the unloading area.

7. An industrial automatic object transportation system, comprising:
a vehicle comprising a body, a plurality of front wheels, a plurality of rear wheels and a fork;
a control circuit mounted in the body and having a programmable capability to perform controlling procedures of operating the body;
a sensing device mounted on a periphery of the body to sense a barrier and an object;
a digital compass device mounted on the body to provide an omnidirectional detection angle and access built-in angle data of the control circuit through a transmission interface; and
a motor control circuit controlling turnings of the rear wheels and moving the vehicle based on the omnidirectional detection angle provided by the digital compass device.

8. The system as claimed in claim 7, wherein the sensing device comprises a plurality of sensors and a wireless reader.

9. The system as claimed in claim 8, wherein each of the sensors comprises a transmitter and a receiver.

10. The system as claimed in claim 8, wherein the wireless reader is an RFID reader.

11. The system as claimed in claim 7, wherein the motor control circuit comprises:
a first motor controller driving the front wheels;
a second motor controller driving the fork; and
a servo motor turning the rear wheels.

12. The system as claimed in claim 7, further comprising:
a camera device providing determination of a plurality of objects that whether a target object is found by a visual identification technique.

13. The system as claimed in claim 7, wherein the transmission interface is a serial interface, and the serial interface is a wireless RS232 converter.
